(19) United States
(12) Patent Application Publication
(10) Pub. No.: US 2014/0092971 A1
(43) Pub. Date: Apr. 3, 2014

(54) PICTURE PROCESSING IN SCALABLE VIDEO SYSTEMS

(71) Applicants: Kiran Mukesh Misra, Vancouver, WA (US); Christopher Andrew Segall, Vancouver, WA (US); Jie Zhao, Vancouver, WA (US)

(72) Inventors: Kiran Mukesh Misra, Vancouver, WA (US); Christopher Andrew Segall, Vancouver, WA (US); Jie Zhao, Vancouver, WA (US)

(21) Appl. No.: 13/631,857

(22) Filed: Sep. 28, 2012

(51) Int. Cl. H04N 7/26; H04N 7/32

(52) U.S. Cl. 375/240.16; 375/240.25; 375/E07.243; 375/E07.027

(57) ABSTRACT

A system utilizing picture processing in a scalable video system is described. The system may include an electronic device configured to recover a picture processing index corresponding to one or more picture processors, e.g. upsamplers, filters, or the like, or any combination thereof. The picture processing index may associate a particular picture processor of a set of picture processors available to the decoder with a unit, e.g. a coding unit or a prediction unit of a coding unit.

### TECHNICAL FIELD

The present disclosure relates generally to electronic devices. More specifically, the present disclosure relates to electronic devices for coding scalable video.

### BACKGROUND

In video coding there is often a significant amount of temporal correlation across pictures/frames. Most video coding standards including the up-coming high efficiency video coding (HEVC) standard exploits this temporal correlation to achieve better compression efficiency for video bitstreams. Some terms used with respect to HEVC are provided in the paragraphs that follow.

A picture is an array of luma samples in monochrome format or an array of luma samples and two corresponding arrays of chroma samples in 4:2:0, 4:2:2, and 4:4:4 colour format.

A coding block is an N×N block of samples for some value of N. The division of a coding tree block into coding blocks is a partitioning

A coding tree block is an N×N block of samples for some value of N. The division of one of the arrays that compose a picture that has three sample arrays or of the array that compose a picture in monochrome format or a picture that is coded using three separate colour planes into coding tree blocks is a partitioning.

A coding tree unit (CTU) a coding tree block of luma samples, two corresponding coding tree blocks of chroma samples of a picture that has three sample arrays, or a coding tree block of samples of a monochrome picture or a picture that is coded using three separate colour planes and syntax structures used to code the samples. The division of a slice into coding tree units is a partitioning.

A coding unit (CU) is a coding block of luma samples, two corresponding coding blocks of chroma samples of a picture that has three sample arrays, or a coding block of samples of a monochrome picture or a picture that is coded using three separate colour planes and syntax structures used to code the samples. The division of a coding tree unit into coding units is a partitioning.

Prediction is defined as an embodiment of the prediction process.

A prediction block is a rectangular M×N block on which the same prediction is applied. The division of a coding block into prediction blocks is a partitioning.

A prediction process is the use of a predictor to provide an estimate of the data element (e.g. sample value or motion vector) currently being decoded.

A prediction unit (PU) is a prediction block of luma samples, two corresponding prediction blocks of chroma samples of a picture that has three sample arrays, or a prediction block of samples of a monochrome picture or a picture that is coded using three separate colour planes and syntax structures used to predict the prediction block samples.

A predictor is a combination of specified values or previously decoded data elements (e.g. sample value or motion vector) used in the decoding process of subsequent data elements.

A tile is an integer number of coding tree blocks co-occurring in one column and one row, ordered consecutively in coding tree block raster scan of the tile. The division of each picture into tiles is a partitioning. Tiles in a picture are ordered consecutively in tile raster scan of the picture.

A tile scan is a specific sequential ordering of coding tree blocks partitioning a picture. The tile scan order traverses the coding tree blocks in coding tree block raster scan within a tile and traverses tiles in tile raster scan within a picture. Although a slice contains coding tree blocks that are consecutive in coding tree block raster scan of a tile, these coding tree blocks are not necessarily consecutive in coding tree block raster scan of the picture.

A slice is an integer number of coding tree blocks ordered consecutively in the tile scan. The division of each picture into slices is a partitioning. The coding tree block addresses are derived from the first coding tree block address in a slice (as represented in the slice header).

A B slice or a bi-predictive slice is a slice that may be decoded using intra prediction or inter prediction using at most two motion vectors and reference indices to predict the sample values of each block.

A P slice or a predictive slice is a slice that may be decoded using intra prediction or inter prediction using at most one motion vector and reference index to predict the sample values of each block.

A reference picture list is a list of reference pictures that is used for uni-prediction of a P or B slice. For the decoding process of a P slice, there is one reference picture list. For the decoding process of a B slice, there are two reference picture lists (list 0 and list 1).

A reference picture list 0 is a reference picture list used for inter prediction of a P or B slice. All inter prediction used for P slices uses reference picture list 0. Reference picture list 0 is one of two reference picture lists used for bi-prediction for a B slice, with the other being reference picture list 1.

A reference picture list 1 is a reference picture list used for bi-prediction of a B slice. Reference picture list 1 is one of two reference picture lists used for bi-prediction for a B slice, with the other being reference picture list 0.

A reference index is an index into a reference picture list.

A picture order count (POC) is a variable that is associated with each picture that indicates the position of the associated picture in output order relative to the output order positions of the other pictures in the same coded video sequence.

A long-term reference picture is a picture that is marked as “used for long-term reference”.

To exploit the temporal correlation in a video sequence, a picture is first partitioned into smaller collection of pixels. In HEVC this collection of pixels is referred to as a prediction unit. A video encoder then performs a search in previously transmitted pictures for a collection of pixels which is closest to the current prediction unit under consideration. The encoder instructs the decoder to use this closest collection of pixels as an initial estimate for the current prediction unit. It may then transmit residue information to improve this estimate. The instruction to use an initial estimate is conveyed to the decoder by means of a signal that contains a pointer to this collection of pixels in the reference picture. More specifically, the pointer information contains an index into a list of reference pictures which is called the reference index and the spatial displacement vector (or motion vector) with respect to the current prediction unit. In some examples, the spatial displacement vector is not an integer value, and as such, the initial estimate corresponds to a representation of the collection of pixels.

To achieve better compression efficiency an encoder may alternatively identify two collections of pixels in one or more reference pictures and instruct the decoder to use a linear combination of the two collections of pixels as an initial estimate of the current prediction unit. An encoder will then need to transmit two corresponding pointers to the decoders each containing a reference index into a list and a motion vector. In general a linear combination of one or more collections of pixels in previously decoded pictures is used to exploit the temporal correlation in a video sequence.

When one temporal collection of pixels is used to obtain the initial estimate we refer to the estimation process as uni-prediction. Whereas, when two temporal collections of pixels are used to obtain the initial estimate we refer to the estimation process as bi-prediction. To distinguish between the uni-prediction and bi-prediction case an encoder transmits an indicator to the decoder. In HEVC this indicator is called the inter-prediction mode. Using this motion information a decoder may construct an initial estimate of the prediction unit under consideration.

To summarize, the motion information assigned to each prediction unit within HEVC consists of the following three pieces of information:
the inter-prediction mode
the reference indices (for list 0 and/or list 1). In an example, list 0 is a first list of reference pictures, and list 0 is a second list of reference pictures, which may have a same combination or a different combination of values than the first list.
the motion vector (for list 0 and/or list 1)

It is desirable to communicate this motion information to the decoder using a small number of bits. It is often observed that motion information carried by prediction units are spatially correlated, i.e. a prediction unit will carry the same or similar motion information as the spatially neighboring prediction units. For example a large object like a bus undergoing translational motion within a video sequence and spanning across several prediction units in a picture/frame will typically contain several prediction units carrying the same motion information. This type of correlation is also observed in co-located prediction units of previously decoded pictures. Often it is bit-efficient for the encoder to instruct the decoder to copy the motion information from one of these spatial or temporal neighbors. In HEVC, this process of copying motion information may be referred to as the merge mode of signaling motion information.

At other times the motion vector may be spatially and/or temporally correlated but there exists pictures other than the ones pointed to by the spatial/temporal neighbors which carry higher quality pixel reconstructions corresponding to the prediction unit under consideration. In such an event, the encoder explicitly signals all the motion information except the motion vector information to the decoder. For signaling the motion vector information, the encoder instructs the decoder to use one of the neighboring spatial/temporal motion vectors as an initial estimate and then sends a refinement motion vector delta to the decoder.

In summary, for bit efficiency HEVC uses two possible signaling modes for motion information:
Merge Mode
Explicit signaling along with advanced motion vector

### Skip mode (or Coding Unit Level Merge Mode)

At the coding unit level a merge flag is transmitted in the bitstream to indicate that the signaling mechanism used for motion information is based on the merging process. In the merge mode a list of up to five candidates is constructed. The first set of candidates is constructed using spatial and temporal neighbors. The spatial and temporal candidates are followed by various bi-directional combinations of the candidates added so far. Zero motion vector candidates are then added following the bi-directional motion information. Each of the five candidates contains all the three pieces of motion information required by a prediction unit: inter-prediction mode, reference indices and motion vector. If the merge flag is true a merge index is signaled to indicate which candidate motion information from the merge list is to be used by all the prediction units within the coding unit.

### Merge Mode

At the prediction unit level a merge flag is transmitted in the bitstream to indicate that the signaling mechanism used for motion information is based on the merging process. If the merge flag is true a merge index into the merge list is signaled for a prediction unit using the merge mode. This merge index uniquely identifies the motion information to be used for the prediction unit.

### Explicit Signaling Along with Advanced Motion Vector Prediction Mode (AMVP)

When the merge flag is false a prediction unit may explicitly receives the inter-prediction mode and reference indices in the bitstream. In some cases, the inter-prediction mode may not be received and inferred based on data received earlier in the bitstream, for example based on slice type. Following this a list of two motion vectors predictors (MVP list) may be constructed using spatial, temporal and possibly zero motion vectors. An index into this list identifies the predictor to use. In addition the prediction unit receives a motion vector delta. The sum of the predictor identified using the index into MVP list and the received motion vector delta (also called motion vector difference) gives the motion vector associated with the prediction unit.

Scalable video coding is known. In scalable video coding, a primary bit stream (called the base layer bitstream) is received by a decoder. In addition, the decoder may receive one or more secondary bitstream(s) (called enhancement layer bitstreams(s)). The function of each enhancement layer bitstream may be: to improve the quality of the base layer bitstream; to improve the frame rate of the base layer bitstream; or to improve the pixel resolution of the base layer bitstream. Quality scalability is also referred to as Signal-to-Noise Ratio (SNR) scalability. Frame rate scalability is also referred to as temporal scalability. Resolution scalability is also referred to as spatial scalability.

Enhancement layer bitstream(s) can change other features of the base layer bitstream. For example, an enhancement layer bitstream can be associated with a different aspect ratio and/or viewing angle than the base layer bitstream. Another aspect of enhancement layer bitstreams is that it is also possible that the base layer bitstream and an enhancement layer bitstream correspond to different video coding standards, e.g. the base layer bitstream may be coded according to a first video coding standard and an enhancement layer bitstream may be coded according to a second different video coding standard.

An ordering may be defined between layers. For example:
Base layer (lowest) [layer 0]
Enhancement layer 0 [layer 1]
Enhancement layer 1 [layer 2]
Enhancement layer n (highest) [layer n+1]

The enhancement layer(s) may have dependency on one another (in an addition to the base layer). In an example, enhancement layer 2 is usable only if at least a portion of enhancement layer 1 has been parsed and/or reconstructed successfully (and if at least a portion of the base layer has been parsed and/or reconstructed successfully).

FIG. 1A illustrates a decoding process for a scalable video decoder with two enhancement layers. A base layer decoder outputs decoded base layer pictures. The base layer decoder also provides metadata, e.g. motion vectors, and/or picture data, e.g. pixel data, to inter layer processing 0. Inter layer processing 0 provides an inter layer prediction to the enhancement layer 0 decoder, which in turn outputs decoded enhancement layer 0 pictures. In an example, the decoded enhancement layer 0 pictures have a quality improvement with respect to decoded base layer pictures. Enhancement layer 0 decoder also provides metadata and/or picture data to inter layer processing 1. Inter layer processing 1 provides an inter layer prediction to the enhancement layer 1 decoder, which in turn outputs decoded enhancement layer 1 pictures. In an example, decoded enhancement layer 1 pictures have increased spatial resolution as compared to decoded enhancement layer 0 pictures.

Prediction may be by uni-prediction or bi-prediction—in the later case there will be two reference indices and a motion vector for each reference index. FIG. 1B illustrates uni-prediction according to HEVC, whereas FIG. 1C illustrates bi-prediction according to HEVC.

Transmission to a decoder, e.g. transmission over a network to the decoder, according to known schemes consumes bandwidth, e.g. network bandwidth. The bandwidth consumed by the transmission to the decoder according to these known schemes is too high for some applications. The disclosure that follows solves this and other problems.

### BRIEF DESCRIPTION OF THE DRAWINGS

FIG. 1A is a block diagram of a scalable decoder.

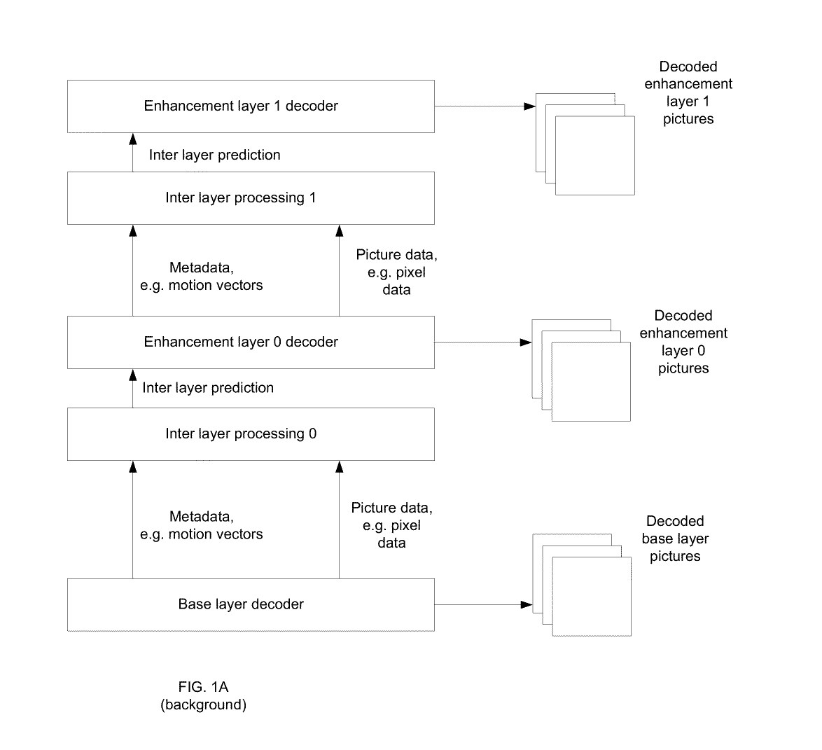

FIG. 1B illustrates uni-prediction according to HEVC.

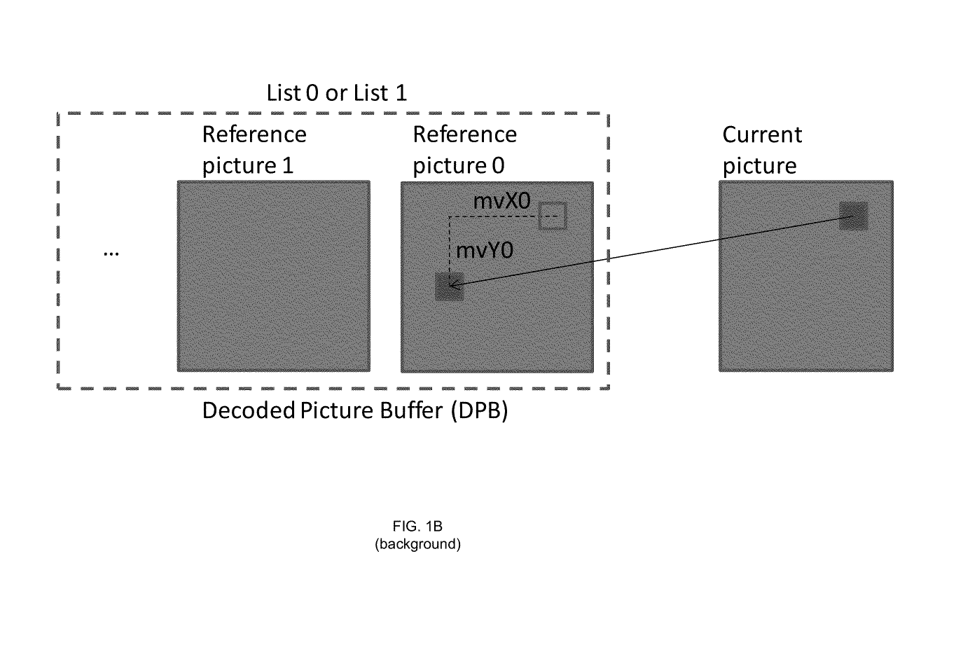

FIG. 1C illustrates bi-prediction according to HEVC.

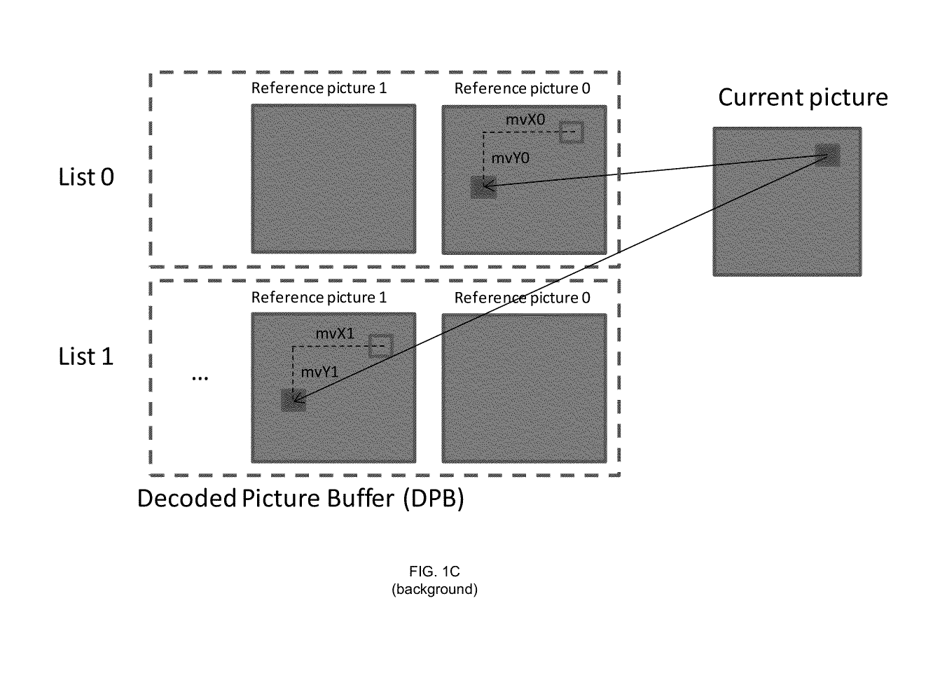

FIG. 2A is a block diagram illustrating an example of an encoder and a decoder.

FIG. 2B is a block diagram illustrating an example of the decoder of FIG. 2A.

FIG. 3A is a flow diagram illustrating one configuration of a method for determining a mode for signaling motion information on an electronic device.

FIG. 3B is a flow diagram illustrating one configuration of a merge process on an electronic device.

FIG. 3C is a flow diagram illustrating one configuration of an explicit motion information transmission process on an electronic device.

FIG. 3D is a flow diagram illustrating one configuration of signaling a reference index and a motion vector on an electronic device.

FIG. 4A is a flow diagram illustrating one configuration of merge list construction on an electronic device.

FIG. 4B is a flow diagram illustrating more of the configuration of merge list construction of FIG. 4A.

FIG. 5 illustrates a plurality of prediction units.

FIG. 6A is a flow diagram illustrating one configuration of motion vector predictor list construction on an electronic device.

FIG. 6B is a flow diagram illustrating more of the configuration of motion vector predictor list construction of FIG. 6A.

FIG. 7A illustrates flow diagrams illustrating an example of processes A and B that may be used for motion vector predictor list construction (FIGS. 6A-C and 7A-C).

FIG. 7B illustrates another example of process B from FIG. 7A.

FIG. 8 is a diagram to illustrate a second layer picture co-located with first layer reference picture for co-located first layer picture.

FIG. 9 is a block diagram to illustrate processing an output of a picture processing in the difference domain.

### DETAILED DESCRIPTION

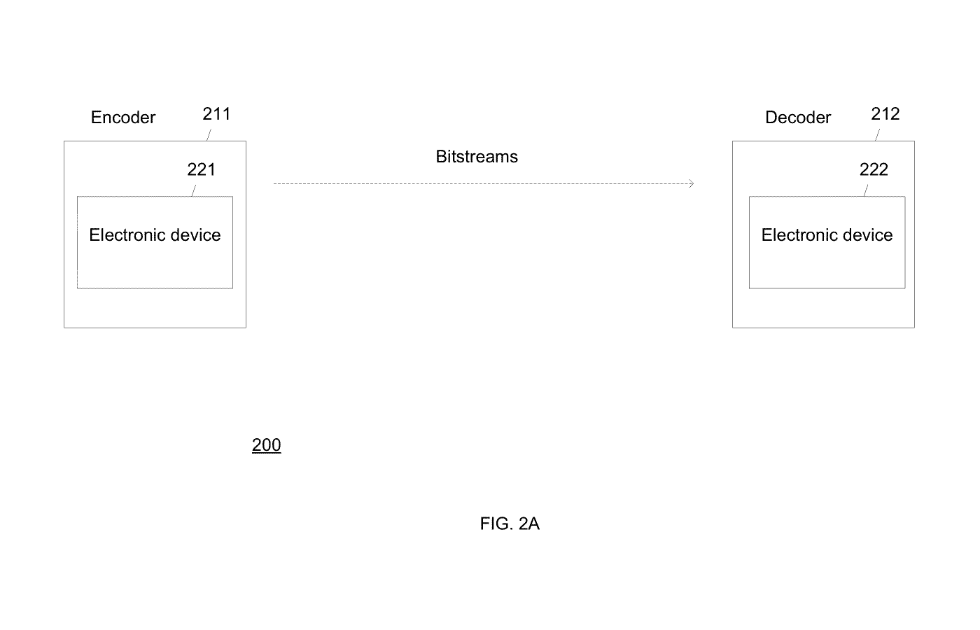

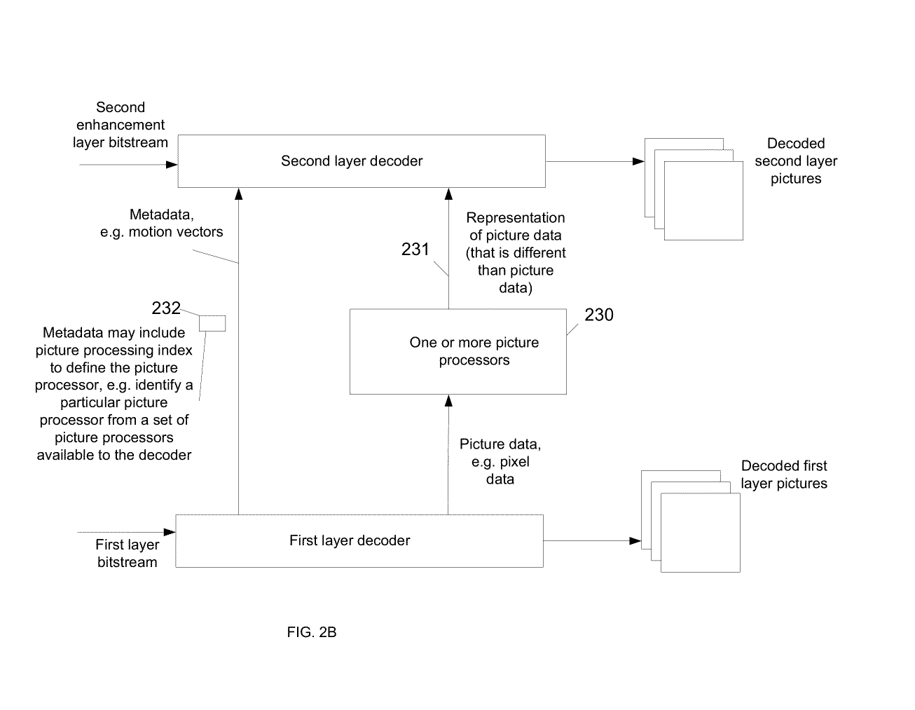

FIG. 2A is a block diagram illustrating an example of an encoder and a decoder.

The system 200 includes an encoder 211 to generate bitstreams to be decoded by a decoder 212. The encoder 211 and the decoder 212 may communicate over a network.

The decoder 212 includes an electronic device 222 configured to decode using some or all of the processes described with reference to the flow diagrams. The electronic device 222 may comprise a processor and memory in electronic communication with the processor, where the memory stores instructions being executable to perform the operations shown in the flow diagrams. The encoder 211 includes an electronic device 221 configured to encode video data to be decoded by the decoder 212.

The electronic device 221 may be configured to signal the electronic device 222 a picture processing index corresponding to one or more picture processors, e.g. upsamplers, filters, or the like, or any combination thereof. The picture processing index may associate a particular picture processor of a set of picture processors available to the decoder 212 with a unit, e.g. a coding unit or a prediction unit of a coding unit. The picture processing index may be associated with a coding unit (for skip mode) and/or a prediction unit (for merge mode and/or explicit transmission mode). The electronic device 221 may be configured to signal the picture processing index using skip mode, merge process, and/or selective explicit signaling.

In an example, the electronic device 221 may be configured to transmit the picture processing index for only selected ones of reference pictures. In an example, the picture processing index is transmitted for a reference picture that is a representation of a first layer picture (that is different than the first layer picture). For another reference picture, the picture processing index may not be transmitted.

In an example, the electronic device 221 may be configured to transmit the picture processing index for only selected ones of reference pictures. In an example, the first picture processing index is transmitted for a reference picture that is a representation of a first layer picture and a second picture processing index is transmitted for a representation of the first layer picture temporally co-located with the current second layer picture. For another reference picture the picture processing index may not be transmitted for a representation of a first layer picture. For another reference picture the picture processing index may not be transmitted for a representation of the first layer picture temporally co-located with the current second layer picture. A temporally co-located first layer picture is the first layer picture which is at the same time instance as the second layer picture.

In an example, the electronic device 222 may be configured to recover a picture processing index for only a portion of the prediction units. In an example, the electronic device 222 may be configured to infer some or all of a picture processing index for a prediction unit from a neighbor prediction unit. Therefore, for some prediction units, the picture processing index may not be transmitted completely or at all.

FIG. 2B is a block diagram illustrating an example of the decoder 212 of FIG. 2A. Referring to FIG. 2B, the decoder 212 receives a first layer bitstream, e.g. a base layer bitstream or an enhancement layer bitstream, and a second layer bitstream, e.g. an enhancement layer bitstream that is dependent on the first layer bitstream.

The metadata output by the first layer decoder may include a picture processing index 232 to define the picture processor 230, e.g. identify a particular picture processor from a set of picture processors available to the decoder 212. The metadata carried by second layer bitstream may include a picture processing index to define the picture processor 230, e.g. identify a particular picture processor from a set of picture processors available to the decoder 212.

The picture processor 230 receives picture data, e.g. pixel data, from a decoded picture buffer of the first layer decoder. For some prediction processes, for example intra prediction, the decoded picture buffer may represent pixel data obtained from partially decoded pictures.

The picture processors 230 generates the representation 231 based on the input picture data, and provides the representation 231 to a decoded picture buffer of the second layer decoder. In an example, the representation 231 may have a different spatial resolution than the input pixel data, e.g. higher spatial resolution when the picture processing comprises upsampling. In an example, the representation 231 may have the same spatial resolution as the input pixel data.

In an example, the picture processing index refers to picture processors within a set of picture processors for all components of the image, e.g. luma and chroma components. In an example, the picture processing index refers to picture processors within a set of picture processors for only a portion of the components of the image. In an example, a subset of luma and/or chroma components share the same picture processing index.

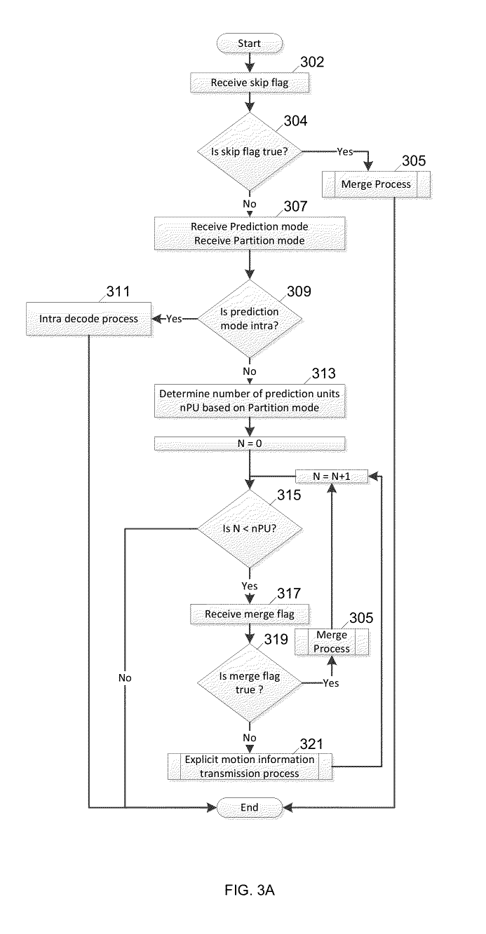

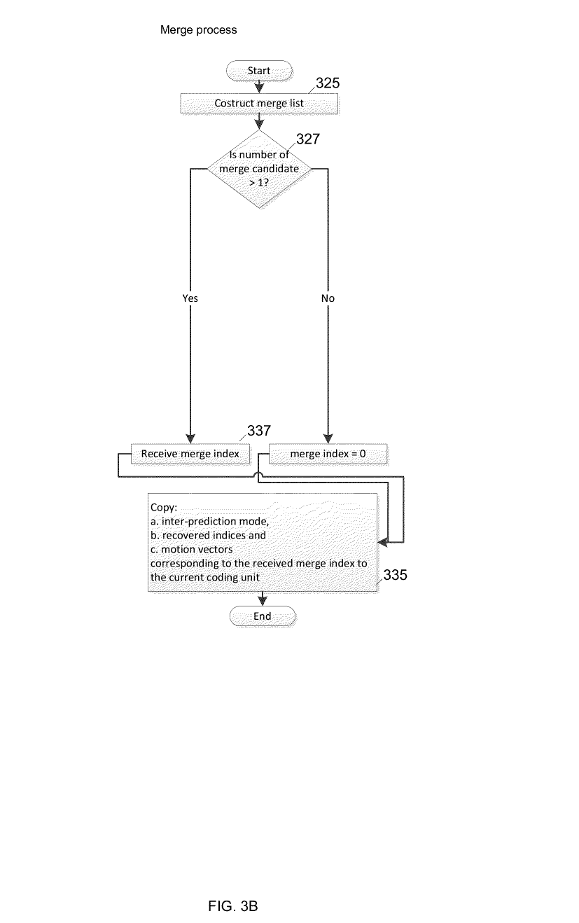

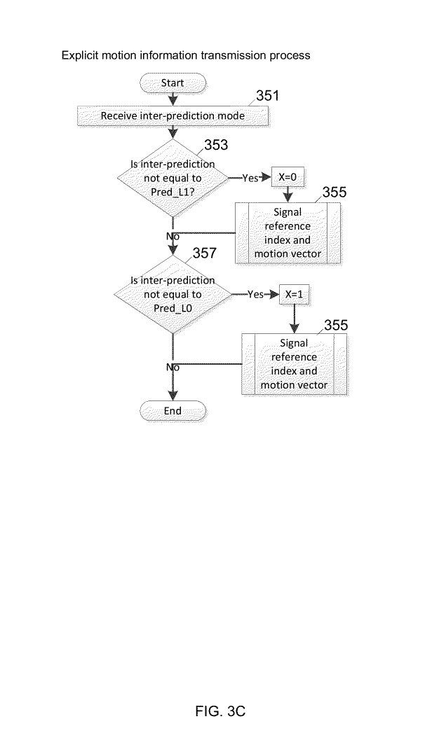

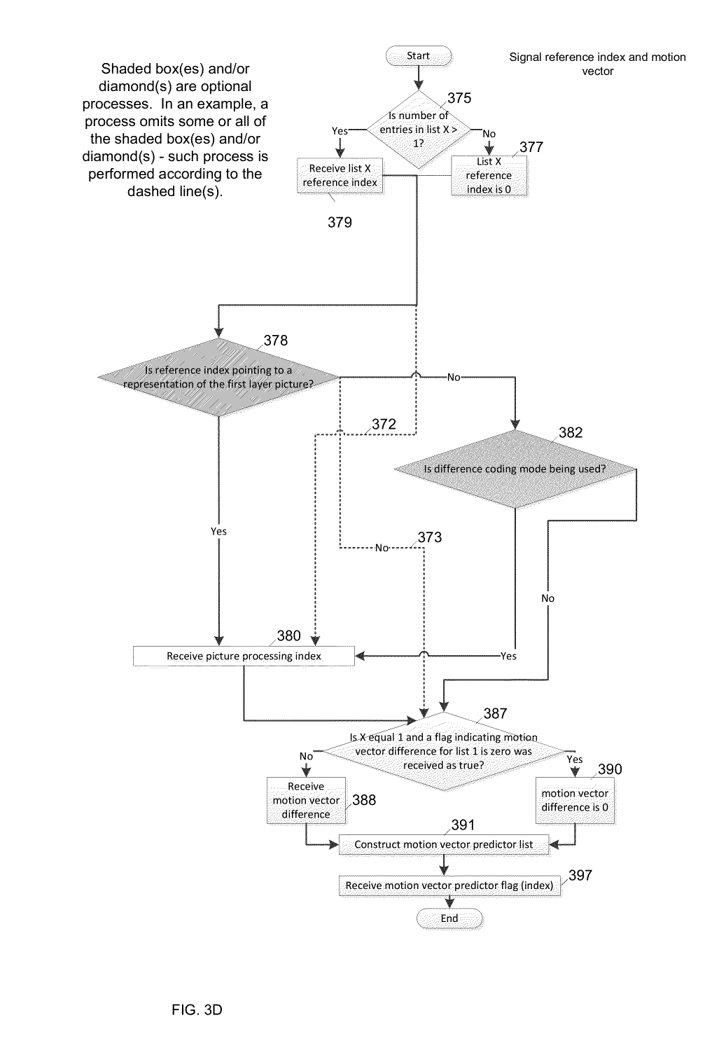

FIG. 3A is a flow diagram illustrating one configuration of a method for determining a mode for signaling motion information on an electronic device.

In process 302, the electronic device 222 receives a skip flag, and in process 304 determines whether the skip flag is true. Skip flags are transmitted for coding units (CUs). The skip flag signals to copy motion information for a neighbor to skip a transmission of motion information for the CU. If the skip flag is true, then in process 305 the electronic device 222 performs the merge process for the CU (the merge process will be discussed in more detail with respect to FIG. 3B).

Still referring to FIG. 3A, in process 307 the electronic device 222 receives a prediction mode flag and a partition mode flag. These flags are transmitted for prediction units (PUs), which are components of the CU. In process 309, the electronic device 222 determines whether the prediction mode is intra. If the prediction mode is intra, then in process 311 the electronic device 222 performs intra decoding (no motion information is transmitted).

If the prediction mode is not intra, e.g. prediction mode is inter, then in process 313 the electronic device 222 determines the number (n) of prediction units (PUs), i.e. nPUs (motion information may be transmitted in a plurality of units, namely PUs). Starting at N equals 0, the electronic device 222 in process 315 determines whether N less than nPU. If N is less than nPU, then in process 317 the electronic device 222 receives a merge flag. In process 319, the electronic device 222 determines whether the merge flag is true. If the merge flag is true, then in the electronic device 222 performs the merge process 305 for the PU (again, the merge process will be discussed in more detail with respect to FIG. 3B).

Still referring to FIG. 3A, if the merge flag is not true, then in process 321 the electronic device 222 performs an explicit motion information transmission process for the PU (such process will be discussed in more detail with respect to FIG. 3C). The process of FIG. 3A repeats as shown for a different N value.

FIG. 3B is a flow diagram illustrating one configuration of a merge process on an electronic device.

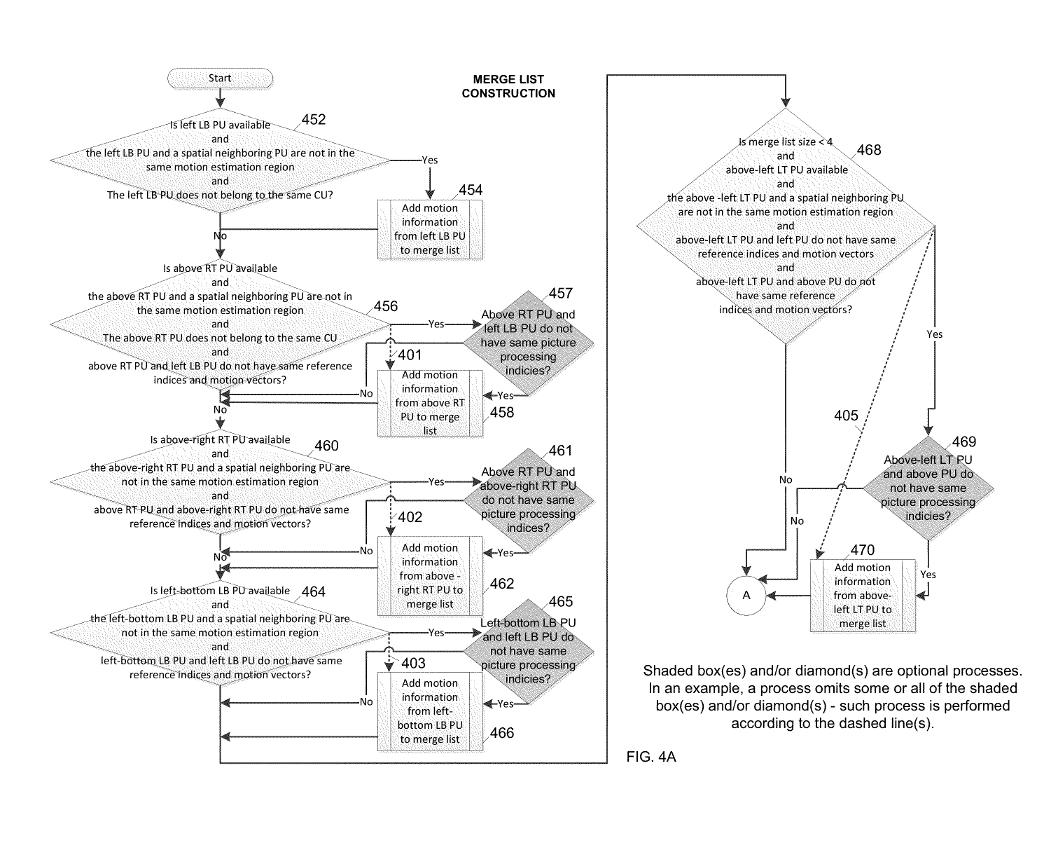

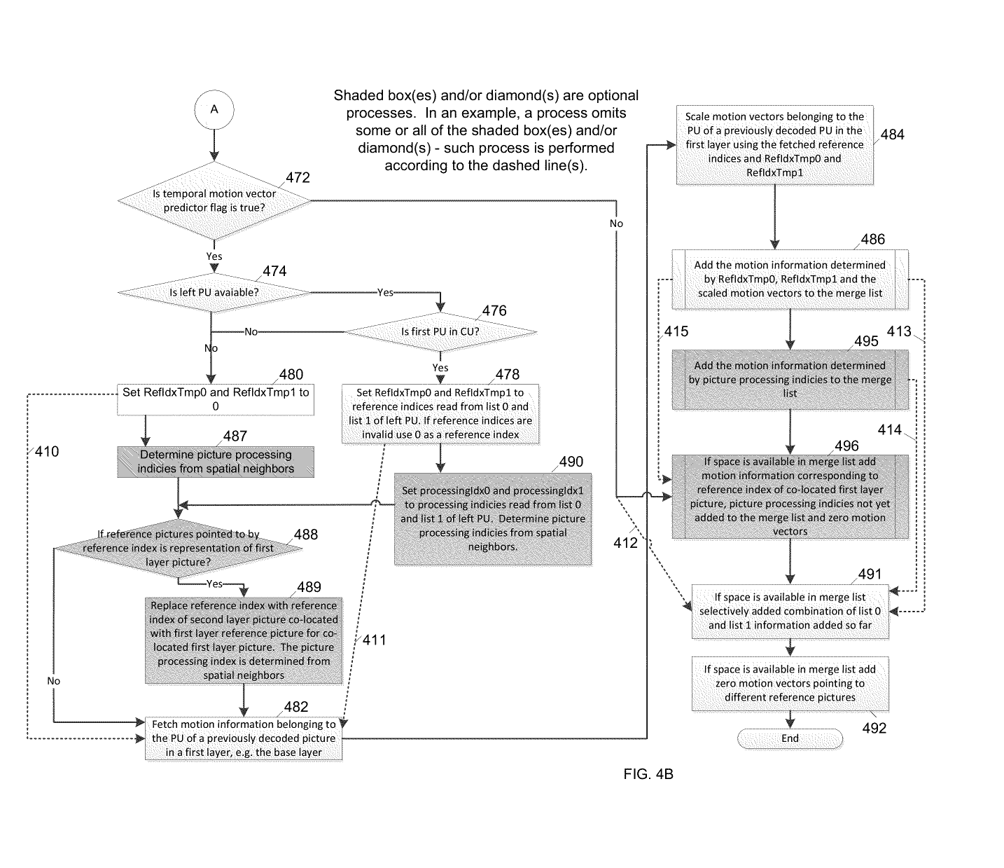

The electronic device 222 in process 325 constructs a merge list (merge list construction will be discussed in more detail with respect to FIGS. 4A-B). Still referring to FIG. 3B, in process 327, the electronic device 222 determines whether a number of merge candidates is greater than 1. If the number is not greater than 1, then the merge index equals 0. The electronic device 222 in process 335 copies, for the current unit, information (such as the inter-prediction mode [indicating whether uni-prediction or bi-prediction and which list], a recovered index such as a reference index and/or the optional picture processing index that will be described later in more detail, and a motion vector) for the candidate corresponding to merge index equals 0.

If the number of merge candidates is greater than 1, the electronic device 222 in process 337 receives the merge index. The electronic device 222 in process 335 copies, for the current unit, information (such as the inter-prediction mode, at least one reference index, and at least one motion vector) for the candidate corresponding to the received merge index.

FIG. 3C is a flow diagram illustrating one configuration of an explicit motion information transmission process on an electronic device.

The electronic device 222 in process 351 receives an inter-prediction mode (again indicating whether uni-prediction or bi-prediction and which list). If the inter-prediction mode indicates that the current PU does not point to list 1, i.e. does not equal Pred_L1, then X equals 0 and the electronic device 222 in process 355 signals reference index and motion vector (such process will be discussed in more detail with respect to FIG. 3D).

Still referring to FIG. 3C, otherwise the electronic device 222 in process 357 determines whether inter-prediction mode indicates that the current PU does not point to list 0, i.e. does not equal Pred_L0, then X equals 1 and the electronic device 222 in process 355 signals reference index and motion vector (such process will be discussed in more detail with respect to FIG. 3D).

FIG. 3D is a flow diagram illustrating one configuration of signaling a reference index and a motion vector on an electronic device.

The electronic device 222 in process 375 determines whether the number of entries in list X greater than 1. If the number of entries in list X is greater than 1, then in process 379 the electronic device 222 receives a list X reference index. If the number of entries in list X is not greater than 1, then in process 377 the list X reference index is equal to 0.

In an example, the electronic device 222 may be configured to perform process 378 indicated by the shaded diamond. In some examples, the electronic device 222 is not configured with processes 378 (in such examples processing continues directly from process 377 or 379 to process 380 along dashed line 372). The optional process 378 will be described in more detail later in the section entitled “Conditional Transmission/Receiving of Picture Processing Index”.

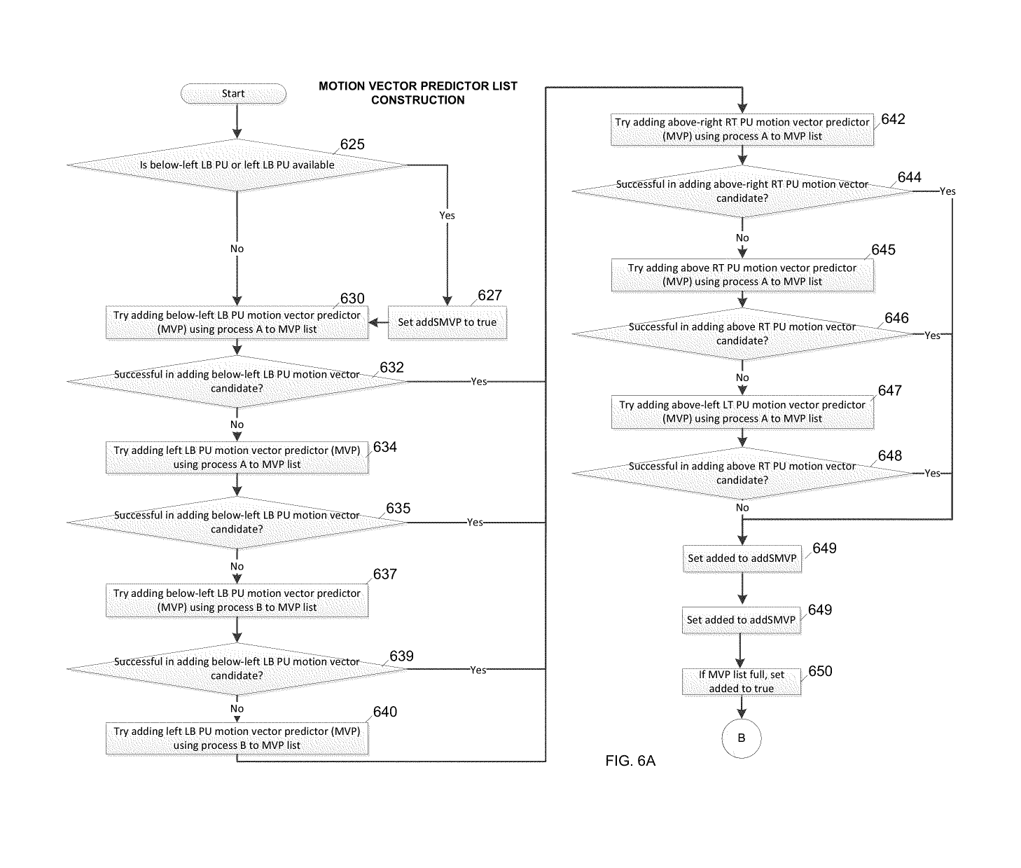

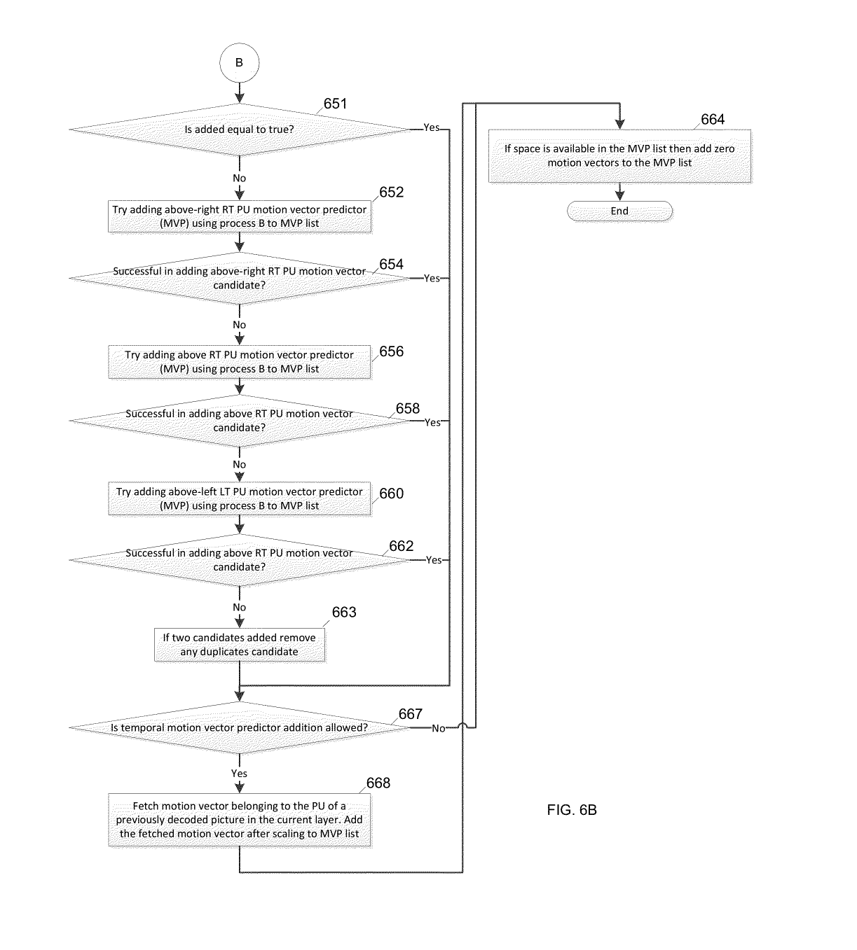

The electronic device 222 in process 380 receives a picture processing index. The electronic device 222 determines in process 387 whether X is equal to 1 and, if so, whether a motion vector difference flag (indicating whether motion vector difference is zero) for list 1 is true. If the flag is not true, then the electronic device 222 in process 388 receives the motion vector difference. If the flag is true, then in process 390 the motion vector difference is zero. The electronic device 222 in process 391 constructs a motion vector predictor list (motion vector predictor list construction will be discussed in more detail with reference to FIGS. 6A-C). The electronic device 222 in process 397 receives a motion vector predictor flag.

FIG. 4A is a flow diagram illustrating one configuration of merge list construction on an electronic device.

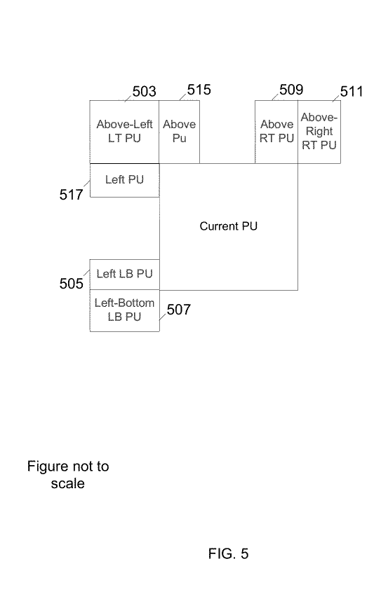

The electronic device 222 in process 452 determines whether conditions corresponding to the left LB PU (FIG. 5, 505) are true. The conditions are: is the left LB PU 505 available; whether the left LB PU 505 and a spatial neighboring PU are not in the same motion estimation region; and whether the left LB PU 505 does not belong to the same CU (as the current PU). One criterion for availability is based on the partitioning of the picture (information of one partition may not be accessible for another partition). Another criterion for availability is inter/intra (if intra, then there is no motion information available). If all conditions are true, then the electronic device 222 in process 454 adds motion information from the left LB PU 505 to the merge list.

The electronic device 222 in process 456 determines whether conditions corresponding to the above RT PU (FIG. 5, 509) are true. In an example, the conditions include: is the above RT PU 509 available; whether the above RT PU and a spatial neighboring PU are not in the same motion estimation region; whether the left LB PU 505 does not belong to the same CU (as the current PU); and whether the above RT PU 509 and the left LB PU 505 do not have the same reference indices and motion vectors.

In an example, the electronic device 222 may be configured to check an additional condition indicated by the shaded diamond 457. In some examples, the electronic device 222 is not configured to check the additional condition (in such examples processing continues directly from process 456 to process 458 along dashed line 401). The additional condition indicated by optional process 457 will be described in more detail later in the section entitled “Merge List Construction Processes for Signaling Picture Processing”.

The electronic device 222 in processes 460 and 464 makes similar determinations for the above-right RT PU (FIG. 5, 511) and the left-bottom LB PU (FIG. 5, 507), respectively. Note that the same-CU condition is not checked in process 460 for above-right RT PU 511 and the same-CU condition is not checked in process 464 for the left-bottom LB PU 507. Additional conditions may be checked as indicated by optional diamonds 461 and 465 and dashed lines 402 and 403. Additional motion information may be added to the merge list in processes 462 and 466.

The electronic device 222 in process 468 determines whether the merge list size less than 4, and whether conditions corresponding to the above-left LT PU (FIG. 5, 503) are true. The conditions include: is the above-left LT PU 503 available; are the above-left LT PU 503 and a spatial neighboring PU not in the same motion estimation region; do the above-left LT PU 503 and a left PU (FIG. 5, 517) not have same reference indices and motion vectors; and do the above-left LT PU 503 and an above PU 515 not have the same indices and motion vectors.

In an example, the electronic device 222 may be configured to check an additional condition indicated by the shaded diamond 469. In some examples, the electronic device 222 is not configured to check the additional condition (in such examples processing continues directly from process 468 to process 470 along dashed line 405). The additional condition indicated by optional process 469 will be described in more detail later in the section entitled “Merge List Construction Processes for Signaling Picture Processing”.

If the merge list size is less than 4 and the checked conditions are all true, then the electronic device 222 in process 470 adds motion information for the above-left LT PU 503 to the merge list. The process continues to FIG. 4B as indicated by the letter “A”.

FIG. 4B is a flow diagram illustrating more of the configuration of merge list construction of FIG. 4A.

The electronic device 222 in process 472 determines whether a temporal motion vector predictor flag (transmitted in an HEVC bitstream) is true. If the temporal motion vector predictor flag is not true, then the electronic device 222 in process 491, if space is available in the merge list, selectively adds bi-directional combinations of the candidates added so far, e.g. known candidates. The electronic device 222 in process 492, if space is available in the merge list, adds zero motion vectors pointing to different reference pictures.

If the temporal motion vector predictor flag is true, then the electronic device 222 may construct a candidate using a reference index from a spatial neighbor and a motion vector from a temporal neighbor. The electronic device 222 in process 474 determines whether a left PU 517 is available. If the left PU 517 is available, then the electronic device 222 in process 476 determines whether the left PU 517 is a first, i.e. initial, PU in the CU. If the left PU 517 is the first PU in the CU, then the electronic device 222 in process 478 sets RefInxTmp0 and RefInxTmp1 to reference indices read from list 0 and list 1 of left PU 517 (if reference indices are invalid then 0 is used as a reference index).

If the left PU 517 is not available or is available but is not the first PU in the CU, then the electronic device 222 in process 480 sets RefInxTmp0 and RefInxTmp1 to 0.

In an example, the electronic device 222 may be configured to perform some or all of processes 487, 488, 489, 490, and 495 indicated by the shaded boxes and/or diamonds. However, in some examples the electronic device 222 is not configured with processes 487, 488, 489, 490, and 495 (in such examples processing continues directly from process 480 or 478 to process 482 along the dashed line 410 or the dashed line 411, and also continues directly from process 486 to process 491 along dashed line 413). The optional processes 487, 488, 489, 490, and 495 will be described in more detail later in the section entitled “Determining Pixel Processing Indices from Spatial Neighbors”.

The electronic device 222 in process 482 fetches motion information belonging to the PU of a previously decoded picture in the current layer. The electronic device 222 in process 484 scales motion vectors belonging to the PU of a previously decoded picture in the current layer using the fetched reference indices and RefInxTmp0 and RefInxTmp1. The electronic device 222 in process 486 adds the motion information determined by RefInxTmp0, RefInxTmp1, and the called motion vectors to the merge list. In an example, the previously decoded picture in the first layer is a picture temporally co-located, e.g. corresponding to the same time instance, with the current picture being coded with the current picture being coded.

In an example, the electronic device 222 may be configured to perform process 496 indicated by the shaded box. However, in some examples the electronic device 222 is not configured with process 496 (in such examples processing continues directly from 472 [no result] to process 491 along dashed line 412 and directly from process 486 to process 491 along the dashed line 413). The optional process 496 will be described in more detail later in the section entitled “Merge List Construction Processes for Signaling Picture Processing”.

The electronic device 222 in process 491, if space is available in the merge list, selectively adds bi-directional combinations of the candidates added so far, e.g. known candidates. The electronic device 222 in process 492, if space is available in the merge list, adds zero motion vectors pointing to different reference pictures.

FIG. 6A is a flow diagram illustrating one configuration of motion vector predictor list construction on an electronic device.

The electronic device 222 in process 625 determines whether at least one of below-left LB PU (not shown) or left LB PU (FIG. 5, 505) is available. The electronic device 222 in process 627 sets a variable addSMVP to true if at least one of such PUs are available.

If neither of such PUs are available, then the electronic device 222 in process 630 tries to add below-left LB PU motion vector predictor (MVP) using process A to MVP list. If not successful, then the electronic device 222 in process 634 tries adding left LB PU MVP using process A to MVP list. If not successful, then the electronic device 222 in process 637 tries adding below-left LB PU MVP using process B to MVP list. If not successful, then the electronic device 222 in process 640 tries adding left LB PU MVP using process B to MVP list. At least one of processes 632, 635, and 639 may be performed.

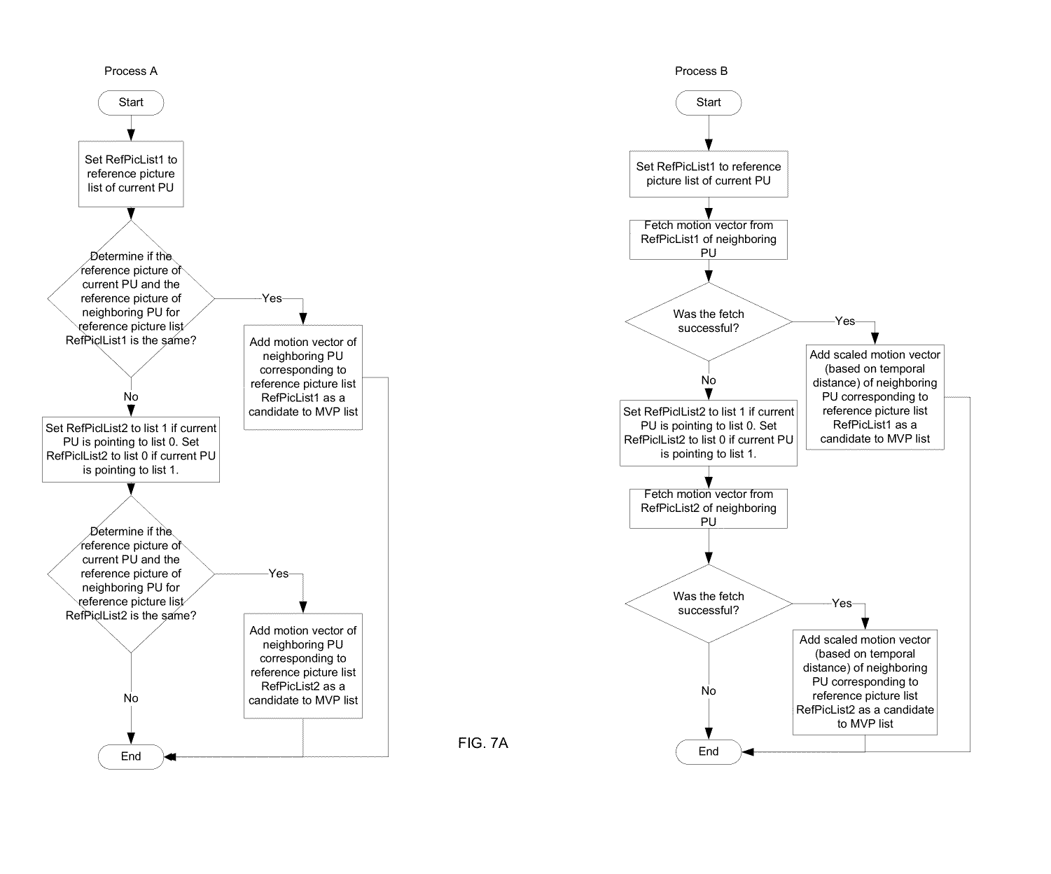

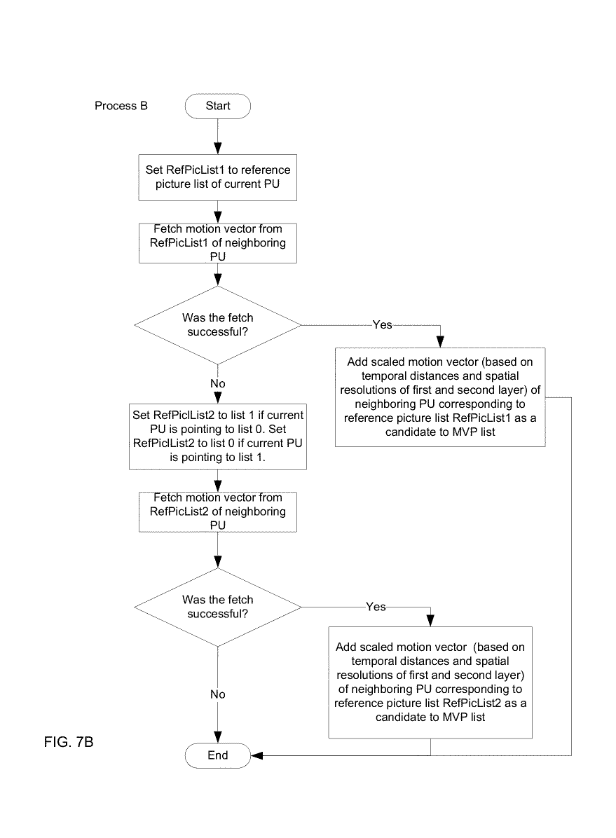

In an example, process A is configured to add a candidate MVP only if a reference picture of a neighboring PU and that of the current PU (i.e. the PU presently under consideration) is/are the same. In an example, process B is a different process than process A. In an example, process B is configured to scale the motion vector of a neighboring PU based on temporal distance and add the result as a candidate to the MVP list. In an example, processes A and B operate as shown in FIG. 7A. Process B of FIG. 7B accounts for the change in spatial resolution across layers. In such an event, the scaling of motion vectors is not only based on temporal distance, but also on the spatial resolutions of the first and second layer.

Referring again to FIG. 6A, if the electronic device 222 in process 642 tries to add above-right RT PU MVP using process A to MVP list. If not successful, then the electronic device 222 in process 645 tries adding above RT PU MVP using process A to MVP list. If not successful, then the electronic device 222 in process 647 tries adding above-left LT PU MVP using process A to MVP list. At least one of processes 644, 646, and 648 may be performed.

The electronic device 222 in process 649 sets the value of a variable “added” to the same value as variable “addSMVP”. The electronic device 222 in process 650 sets the variable “added” to true if the MVP list is full. The process continues to FIG. 6C as indicated by the letter “B”.

FIG. 6B is a flow diagram illustrating more of the configuration of motion vector predictor list construction of FIG. 6A.

The electronic device 222 in process 651 determines whether left-bottom LB or left LB PU 505 are available, i.e. determines whether the variable “added” is set to true. If not, then in process 652 the electronic device 222 tries adding above-right RT PU MVP using process B to MVP list. If not successful, then the electronic device 222 in process 656 tries adding above RT PU MVP using process B to MVP list. If not successful, then the electronic device 222 in process 660 tries adding the above-left LT PU MVP using process B to MVP list. At least one of processes 654, 658, and 662 may be performed. The electronic device 222 in process 663 may remove any duplicate candidates in the MVP list.

The electronic device 222 in process 667 determines whether temporal motion vector predictor addition is allowed, e.g. determines whether the temporal motion vector predictor flag is true. If allowed, the electronic device 222 in process 668 fetches a motion vector belonging to the PU of a previously decoded picture in the current layer, and adds the fetched motion vector after scaling to MVP list. The electronic device 222 in process 664, if space is available in the MVP list, adds zero motion vectors to the MVP list.

### Conditional Transmission/Receiving of Picture Processing Index

Referring to FIG. 3D, the electronic device 222 in process 378 determines whether the reference index is pointing to a representation of the first layer picture. If the reference index is pointing to a representation of the first layer picture, the electronic device 222 in process 380 receives a picture processing index. As will be explained later in greater detail, even if process 380 is not performed (for example because of a no result in process 378), a picture processing index may still be inferred, for example, based on a picture processing index of neighbors (spatial and/or temporal).

In an example, the electronic device 222 receives a reference index. The electronic device 222 is configured to determine whether a reference picture (determined using the reference index) is a representation of a first layer picture that is different than the first layer picture, e.g. is an upsampled first layer picture, a filtered first layer picture, or the like. The electronic device 222 is configured to, responsive to determining that the reference picture is the representation of the first layer picture that is different than the first layer picture, receive a picture processing index. Otherwise, the picture processing index is not received.

In an example, the electronic device 222 may be configured to perform process 382 indicated by the shaded diamond. In some examples, the electronic device 222 is not configured with processes 382 (in such examples processing continues directly from process 379 [yes path] along dashed line 373). The optional process 382 will be described in more detail later in the section entitled “Conditional Transmission/Receiving of Picture Processing Index in Systems Carrying out Prediction in the Difference Domain”.

### Merge List Construction Processes for Signaling Picture Processing

Referring now to FIG. 4A, in an example the electronic device 222 is configured to determine whether the above RT PU (FIG. 5, 503) and left LB PU (FIG. 5, 505) do not have the same picture processing indices as indicated by diamond 457. If this condition and the conditions indicated by diamond 456 are all true, then the electronic device 222 performs previously described process 458. It should be appreciated that checking the conditions indicated in diamonds 456 and 457 may comprise any number of processes, e.g. a single process, two processes, one process for each condition, etc., and the disclosure is not limited in this respect.

In an example, the electronic device 222 is configured to determine whether the above RT PU (FIG. 5, 509) and above-right RT PU (FIG. 5, 511) do not have the same picture processing indices as indicated by diamond 461. If this condition and the conditions indicated by diamond 460 are all true, then the electronic device 222 performs previously described process 462. It should be appreciated that checking the conditions indicated in diamonds 460 and 461 may comprise any number of processes, e.g. a single process, two processes, one process for each condition, etc., and the disclosure is not limited in this respect.

In an example, the electronic device 222 is configured to determine whether the left-bottom LB PU (FIG. 5, 507) and left LB PU 505 do not have the same picture processing indices as indicated by diamond 465. If this condition and the conditions indicated by diamond 464 are all true, then the electronic device 222 performs previously described process 466. It should be appreciated that checking the conditions indicated in diamonds 464 and 465 may comprise any number of processes, e.g. a single process, two processes, one process for each condition, etc., and the disclosure is not limited in this respect.

In an example the electronic device 222 is configured to determine whether the above-left LB PU (FIG. 5, 503) and above PU (FIG. 5, 515) do not have the same picture processing indices as indicated by diamond 469. If this condition and the conditions indicated by diamond 468 are all true, then the electronic device 222 performs previously described process 470. It should be appreciated that checking the conditions indicated in diamonds 468 and 469 may comprise any number of processes, e.g. a single process, two processes, one process for each condition, etc., and the disclosure is not limited in this respect.

### Determining Picture Processing Indices from Spatial Neighbors

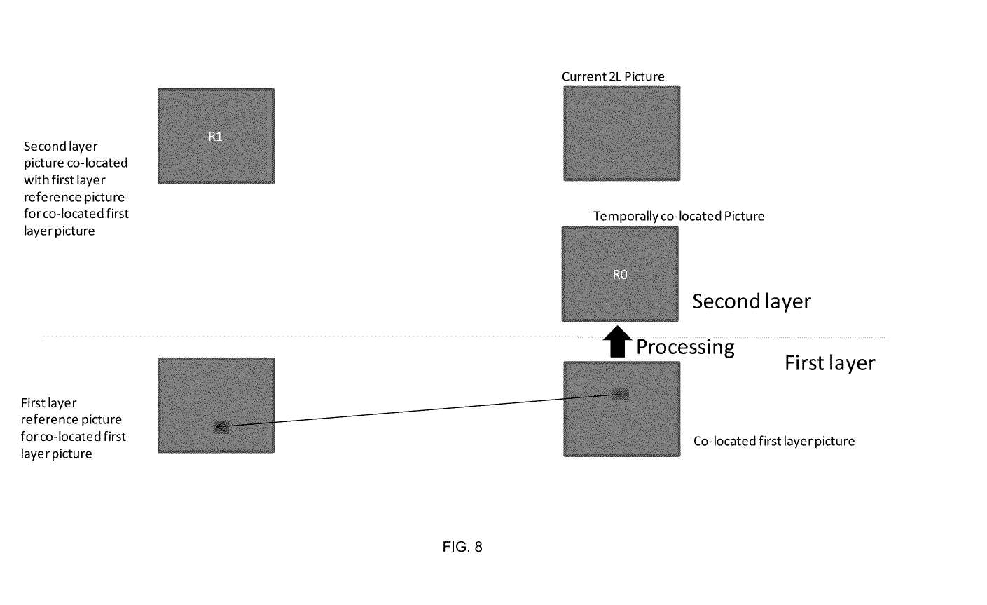

Referring now to FIG. 4B, in an example the electronic device 222 in process 487 determines picture processing indices from spatial neighbors. The electronic device 222 in process 490 sets processing index 0 and processing index 1 to processing indices read from list 0 and list 1 of left PU 517, and determines picture processing indices from spatial neighbors. The electronic device 222 in process 488 determines whether reference picture(s) pointed to by the reference index is a representation of a first layer picture. If the reference picture(s) pointed to by the reference index is a representation of a first layer picture, then the electronic device 222 in process 489 replaces the reference index with a reference index of the second layer picture co-located with the first layer reference picture for co-located first layer picture as shown (referring to FIG. 8, R1 is the second layer picture co-located with first layer reference picture for co-located first layer picture), and determines the picture processing index from spatial neighbors. The process continues to previously described process 482.

The electronic device 222 in process 495 adds to the motion information existing in the merge list the determined picture processing indices. In an example, the process continues directly from process 495 to previously described process 491 along the dashed line 414.

In an example, the electronic device 222 is configured to determine the number of times each picture processing index appears in a subset of neighbors. The list may then be ordered according to the determined number. The electronic device 222 may be configured to select, as a representative picture processing index for the current PU or CU, a picture processing index corresponding to a predefined position in the ordering of list, e.g. an initial position in the ordering that correspond to the most number of times. Alternatively, the electronic device 222 is configured to select the picture processing index corresponding to the media count as the representative picture processing index for the current PU. In an example, the spatial neighbors considered are Left LB PU, above RT PU, above-right RT PU, left bottom LB PU, and above left LT PU. If no neighbors are available, then a predetermined picture processing index may be chosen as the representative picture processing index for the current PU.

### Adding Picture Processing Indices to the Merge List

In an example, the electronic device 222 in process 496 adds motion information corresponding to the reference index of the co-located first layer picture, picture processing indices not yet added to the merge list, and zero motion vectors. In an example, such motion information, picture processing indices, and zero motion vectors are added after selectively adding bi-directional combinations of the candidates added so far, e.g. known candidates. In an example, the process continues directly from previously described process 486 to optional process 496 along the dashed line 415.

### Conditional Transmission/Receiving of Picture Processing Index in Systems Carrying out Prediction in the Difference Domain

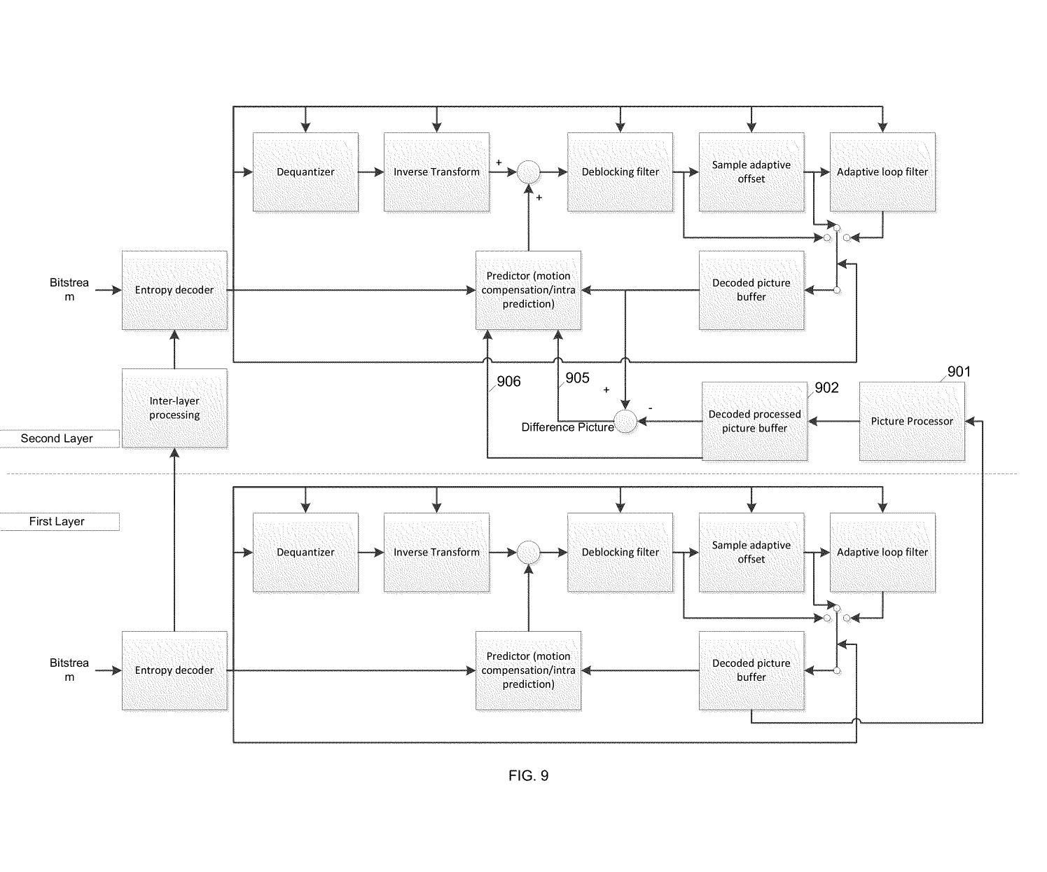

In some scalable systems, prediction may be carried out in a difference domain instead of the pixel domain. For such a system, the decoder 212 (FIG. 2) may include the components shown in FIG. 9.

Referring to FIG. 9, a picture processor 901 receives the picture data from the first layer, and provides a representation of the same in the decoded processed picture buffer 902. A comparator determines a difference between the representation and a picture from the buffer 902, and outputs a difference picture 905. The representation 906 and the difference picture 905 are provided to the predictor.

Referring now to FIG. 3D, the processing device 222 in process 382 determines whether a difference coding mode is being used. If either the reference index is pointing to a representation of the first layer picture (379) or a difference coding mode is being used, then the processing device 222 in process 380 receives the picture processing index. In an example, a difference coding flag indicates whether or not difference coding mode is being used. In an example, a process continues directly from blocks 377/379 to diamond 382 (such example does not include process 378).

### Index to List of Picture Processing Indices

In an example, the electronic device 222 generates a list based on picture processing indices in the neighborhood of a current prediction unit. The electronic device 222 receives from the electronic device 221 an index into this list for a unit. In an example, the index into the list may be explicitly signaled.

In an example, the electronic device 222 is configured to determine the number of times each picture processing index appears in a subset of neighbors. The list may then be ordered according to the determined number. The electronic device 222 may be configured to select, as a representative picture processing index for the current PU or CU, a picture processing index corresponding to a predefined position in the ordering of list, e.g. an initial position in the ordering that correspond to the most number of times. Alternatively, the electronic device 222 is configured to select the picture processing index corresponding to the media count as the representative picture processing index for the current PU. In an example, the spatial neighbors considered are Left LB PU, above RT PU, above-right RT PU, left bottom LB PU, and above left LT PU. If no neighbors are available, then a predetermined picture processing index may be chosen as the representative picture processing index for the current PU.

In an example, a system is provided. The system may include an electronic device of a decoder, the electronic device configured to: receive a first layer bitstream and a second enhancement layer bitstream corresponding to the first layer bitstream; obtain a reference index for recovering an enhancement layer picture; determine whether a reference picture pointed to by the obtained reference index is a first layer picture representation that is different than a first layer picture; responsive to determining that the reference picture is the first layer picture representation that is different than the first layer picture, recover a picture processing index; and responsive to recovering the picture processing index, recover the enhancement layer picture and store the recovered enhancement layer picture in a memory device.

In an example, the picture processing index points to a picture processor of a set of picture processors.

In an example, the set of picture processors comprises at least one upsampler.

In an example, the set of picture processors comprises at least one filter.

In an example, the electronic device is further configured to: determine whether a difference coding mode is being used; and recover the picture processing index responsive to determining that the difference coding mode is being used.

In an example, the electronic device is further configured to: determine, for a selected Prediction Unit (PU), conditions including: is the selected PU available, are the selected PU and a spatial neighboring PU not in a same motion estimation region, do the selected PU and a previously selected PU have a same reference index and motion vector, and do the selected PU and a previously selected PU not have a same picture processing index; responsive to determining that the included conditions are all true, add motion information from the selected PU to a merge list.

In an example, the determined conditions further include: do the selected PU and a currently considered PU belong to a same Coding Unit (CU).

In an example, the electronic device is further configured to, responsive to determining that the reference picture is the first layer picture representation that is different than the first layer picture, replace a reference index in a merge list with a different reference index.

In an example, the electronic device is further configured to add motion information determined by the recovered picture processing index to a merge list.

In an example, the electronic device is further configured to add the recovered picture processing index to the merge list.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. One or more of the operations, processes, and/or methods described herein may be performed by an apparatus, a device, and/or a system substantially similar to those as described herein and with reference to the illustrated figures.

A processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long as the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

One of skill in the art will recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A system, comprising:
an electronic device of a decoder, the electronic device configured to:
receive a first layer bitstream and a second enhancement layer bitstream corresponding to the first layer bitstream;
obtain a reference index for recovering an enhancement layer picture;
determine whether a reference picture pointed to by the obtained reference index is a first layer picture representation that is different than a first layer picture;
responsive to determining that the reference picture is the first layer picture representation that is different than the first layer picture, recover a picture processing index; and
responsive to recovering the picture processing index, recover the enhancement layer picture and store the recovered enhancement layer picture in a memory device.

2. The system of claim 1, wherein the picture processing index points to a picture processor of a set of picture processors.

3. The system of claim 2, wherein the set of picture processors comprises at least one upsampler.

4. The system of claim 2, wherein the set of picture processors comprises at least one filter.

5. The system of claim 1, wherein the electronic device is further configured to:
determine whether a difference coding mode is being used; and
recover the picture processing index responsive to determining that the difference coding mode is being used.

6. The system of claim 1, wherein the electronic device is further configured to:
determine, for a selected Prediction Unit (PU), conditions including: is the selected PU available, are the selected PU and a spatial neighboring PU not in a same motion estimation region, do the selected PU and a previously selected PU have a same reference index and motion vector, and do the selected PU and a previously selected PU not have a same picture processing index;
responsive to determining that the included conditions are all true, add motion information from the selected PU to a merge list.

7. The system of claim 6, wherein the determined conditions further include: do the selected PU and a currently considered PU belong to a same Coding Unit (CU).

8. The system of claim 1, wherein the electronic device is further configured to, responsive to determining that the reference picture is the first layer picture representation that is different than the first layer picture, replace a reference index in a merge list with a different reference index.

9. The system of claim 1, wherein the electronic device is further configured to add motion information determined by the recovered picture processing index to a merge list.

10. The system of claim 1, wherein the electronic device is further configured to add the recovered picture processing index to the merge list.

11. A method, comprising:
receiving a first layer bitstream and a second enhancement layer bitstream corresponding to the first layer bitstream;
obtaining a reference index for recovering an enhancement layer picture;
determining whether a reference picture pointed to by the obtained reference index is a first layer picture representation that is different than a first layer picture;
responsive to determining that the reference picture is the first layer picture representation that is different than the first layer picture, recovering a picture processing index; and
responsive to recovering the picture processing index, recovering the enhancement layer picture and store the recovered enhancement layer picture in a memory device.

12. The method of claim 11, wherein the picture processing index points to a picture processor of a set of picture processors.

13. The method of claim 12, wherein the set of picture processors comprises at least one upsampler.

14. The method of claim 12, wherein the set of picture processors comprises at least one filter.

15. The method of claim 11, further comprising:
determining whether a difference coding mode is being used; and
recovering the picture processing index responsive to determining that the difference coding mode is being used.

16. The method of claim 11, further comprising:
determining, for a selected Prediction Unit (PU), conditions including: is the selected PU available, are the selected PU and a spatial neighboring PU not in a same motion estimation region, do the selected PU and a previously selected PU have a same reference index and motion vector, and do the selected PU and a previously selected PU not have a same picture processing index;
responsive to determining that the included conditions are all true, adding motion information from the selected PU to a merge list.

17. The method of claim 16, wherein the determined conditions further include do: the selected PU and a currently considered PU belong to a same Coding Unit (CU).

18. The method of claim 11, further comprising, responsive to determining that the reference picture is the first layer picture representation that is different than the first layer picture, replacing a reference index in a merge list with a different reference index.

19. The method of claim 11, further comprising adding motion information determined by the recovered picture processing index to a merge list.

20. The method of claim 11, further comprising adding the recovered picture processing index to the merge list.
